(19) United States
(12) Patent Application Publication
(10) Pub. No.: US 2025/0262889 A1
(43) Pub. Date: Aug. 21, 2025

(54) WHEEL COVER RETENTION ASSEMBLY

(71) Applicant: Ford Global Technologies, LLC, Dearborn, MI (US)

(72) Inventors: Erick Juan Bautista, Mexico City (MX); Emilio Rocha, Tlanepantla de Baz (MX); Mark Aldo Peschiutta, Rochester Hills, MI (US)

(21) Appl. No.: 18/581,022

(22) Filed: Feb. 19, 2024

(51) Int. Cl. B60B 7/10

(52) U.S. Cl. CPC B60B 7/10

(57) ABSTRACT

A wheel cover may include a cover portion that may include an interior surface that may face inwardly towards the wheel and an exterior surface that may face outwardly away from the wheel, and a retention assembly which may be disposed at the interior surface, the retention assembly may operably couple the wheel cover to the wheel. The retention assembly may include a first retention clip that may extend perpendicularly away from the interior surface and may interface with a retention notch of the wheel, and a first biasing member which may operably couple to a front side and a back side of the first retention clip. The first biasing member may bias the first retention clip to operably couple with the retention notch by engaging the front side to urge the back side in a radially outward direction with respect to the cover portion.

### TECHNICAL FIELD

Example embodiments generally relate to wheel covers and, more particularly, relate to a retention assembly for securing a wheel cover to a wheel of a vehicle.

### BACKGROUND

Many modern vehicles, including battery electric vehicles (BEV), hybrid electric vehicles (HEV) and internal combustion engine vehicles (ICE), may wish to maximize efficiency and thus achieve a maximum possible operating range. To accomplish this goal, vehicles are being produced including increasingly lighter weight components, and more aerodynamic components, to reduce weight and drag coefficient of the vehicle. One example of a common component used among modern vehicles may be alloy wheels due to their relatively low weight and high durability compared to other types of wheels. To add to the aerodynamic performance of the alloy wheels, and thus reduce their drag coefficient, many vehicles may include the option of having wheel covers disposed on the wheels to provide a more aerodynamic design that generates less drag and increases the overall efficiency and operating range of the vehicle.

The wheel covers may be made from a plastic, polymer or composite material due to their low weight and ease of manufacturing. The task of securing the wheel covers to the wheel in a reliable and efficient manner has led many current designs to secure the wheel cover to the wheel permanently via fasteners, or in some other cases to secure the wheel cover to the wheel using complex clip and spring combinations. Thus, there may be a need to design a retention assembly to secure the wheel cover to the wheels in a reliable, efficient, and easy to install manner.

### BRIEF SUMMARY OF SOME EXAMPLES

In accordance with an example embodiment, a wheel cover for a wheel of a vehicle of an example embodiment may therefore be provided. The wheel cover may include a cover portion that may include an interior surface that may face inwardly towards the wheel and an exterior surface that may face outwardly away from the wheel, and a retention assembly which may be disposed at the interior surface, the retention assembly may operably couple the wheel cover to the wheel. The retention assembly may include a first retention clip that may extend perpendicularly away from the interior surface and may interface with a retention notch of the wheel, and a first biasing member which may operably couple to a front side and a back side of the first retention clip. The first biasing member may bias the first retention clip to operably couple with the retention notch by engaging the front side to urge the back side in a radially outward direction with respect to the cover portion.

In another example embodiment, a retention assembly for operably coupling a wheel cover to a wheel of a vehicle may be provided. The retention assembly may include a first retention clip that may extend perpendicularly away from an interior surface of the wheel cover and may interface with a retention notch of the wheel, and a first biasing member which may operably couple to a front side and a back side of the first retention clip. The first biasing member may bias the first retention clip to operably couple with the retention notch by engaging the front side to urge the back side in a radially outward direction with respect to the cover portion.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a retention clip for a wheel cover in accordance with an example embodiment;

FIG. 2 depicts a perspective view of the retention clip in accordance with an example embodiment;

FIG. 3 depicts a front view of the retention clip in accordance with an example embodiment;

FIG. 4 illustrates a top view of the retention clip in accordance with an example embodiment;

FIG. 5 illustrates a side view of the retention clip in accordance with an example embodiment;

FIG. 6 illustrates a rear perspective view of the retention clip in accordance with an example embodiment;

FIG. 7 illustrates a section view of the retention clip operably coupling the wheel cover to the wheel in accordance with an example embodiment;

FIG. 8 illustrates a perspective view of a retention assembly of the wheel cover in accordance with an example embodiment;

FIG. 9 illustrates a rear perspective view of the wheel cover operably coupled to the wheel in accordance with an example embodiment;

FIG. 10 illustrates a close up rear perspective view of the wheel cover operably coupled to the wheel taken from box 10 in FIG. 9 in accordance with an example embodiment; and

FIG. 11 illustrates a front perspective view of the wheel cover operably coupled to the wheel.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may address the problems described above. In this regard, for example, some embodiments may provide a retention assembly for a wheel cover for a wheel of a vehicle that may make the wheel cover simpler to install and remove, more durable and more efficient. Some embodiments may provide for the retention assembly to be disposed radially around the wheel cover to operably couple the wheel cover to the wheel with a more even distribution of force around the wheel cover. As a result, installation of the wheel cover may require less effort, less time and thus may be more efficient. Additionally, the wheel cover may be more robustly operably coupled to the wheel, and thus the wheel cover may be less likely to be inadvertently removed from the wheel and the retention assembly may be stronger.

In some cases, the retention clip 100 may be a part of a retention assembly 110 of a wheel cover 120. The retention assembly 110, which may include a plurality of individual retention clips 100, among other components, may operably couple the wheel cover 120 to a wheel 130 of a vehicle. The wheel cover 120 of some example embodiments may include a cover portion 122, and the cover portion 122 may include an interior surface 124 that may face inwardly towards the wheel 130 and an exterior surface 126 that may face outwardly away from the wheel 130 when the wheel cover 120 may be operably coupled to the wheel 130. The cover portion 122 may provide aerodynamic design enhancements to the wheel 130 (i.e. a reduced drag coefficient of the wheel 130) by covering the wheel 130 and redirecting airflow to flow by the wheel 130 smoother when the vehicle is driven. The retention assembly 110 may therefore operably couple the wheel cover 120 to an outer face of the wheel 130 such that wheel spokes 230 may be covered by the cover portion 122.

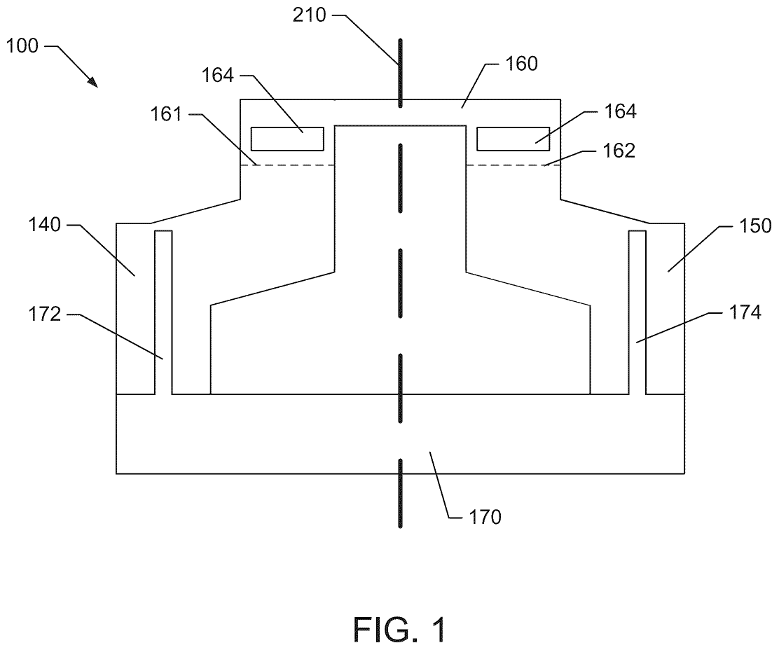

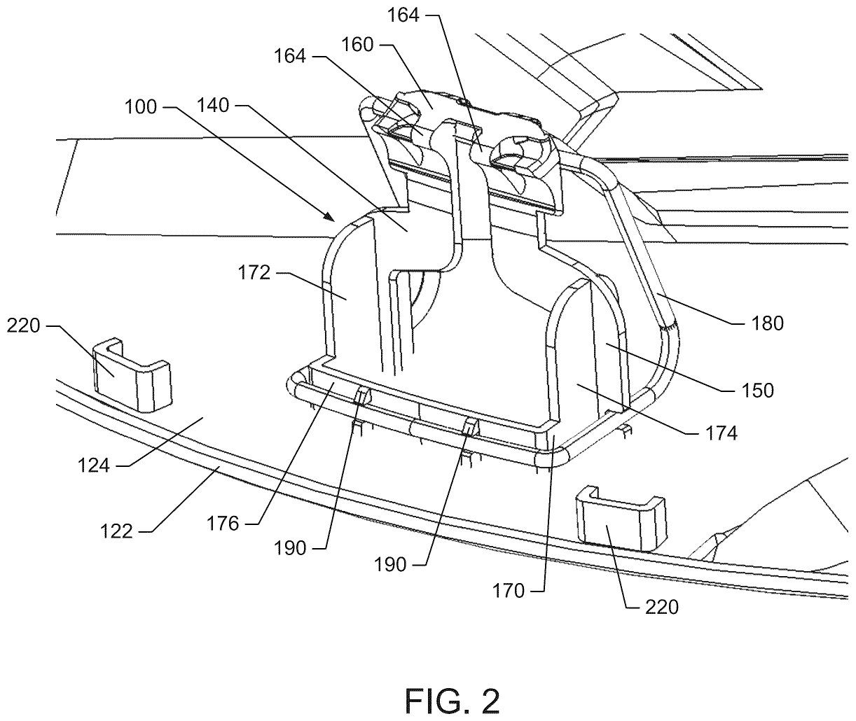

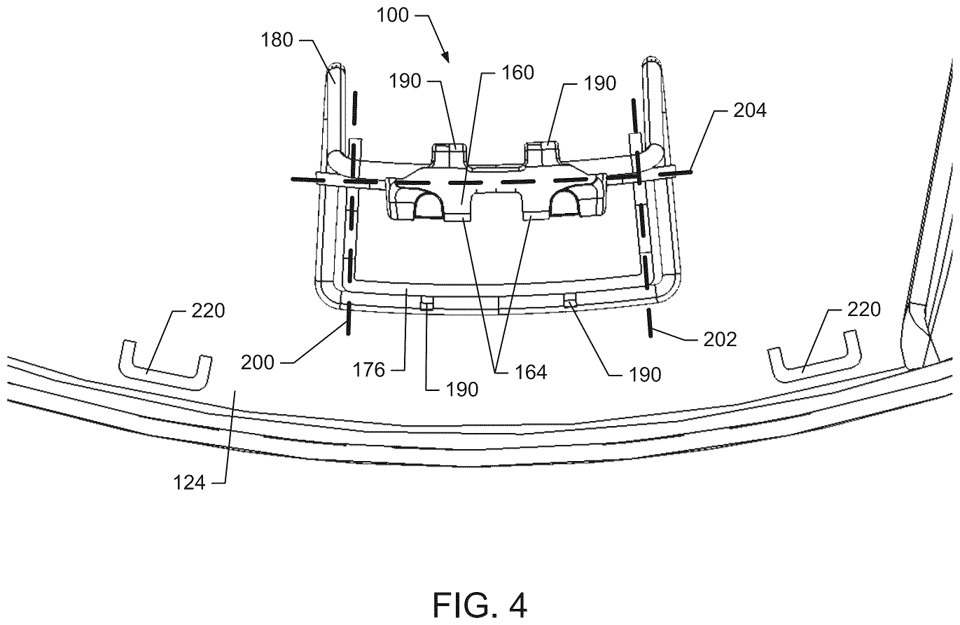

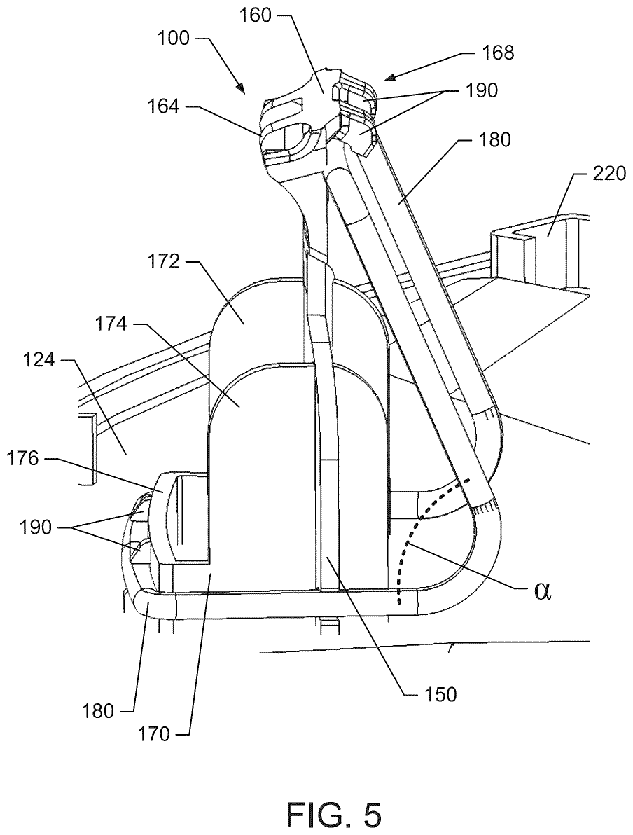

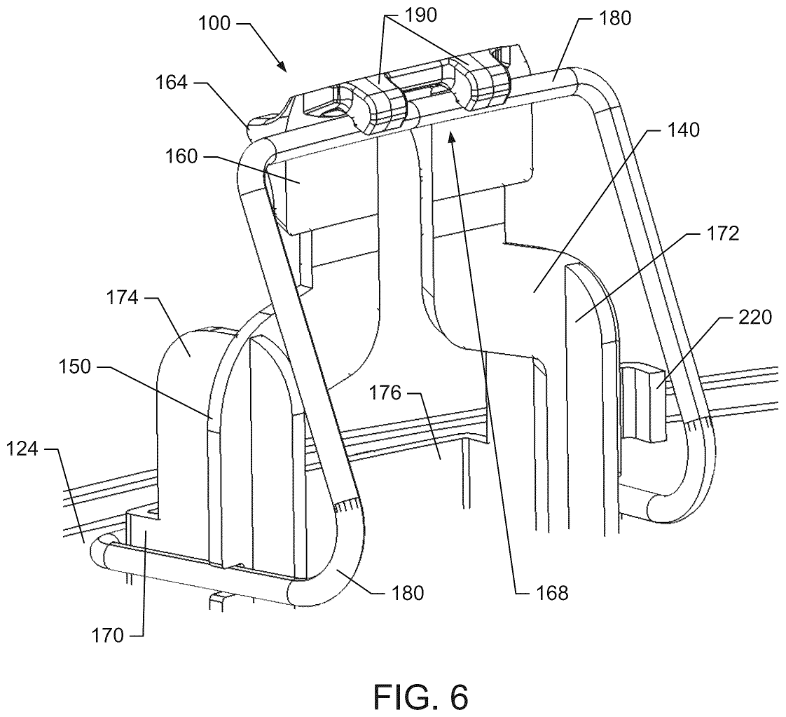

FIG. 1 depicts a block diagram of a retention clip 100 according to an example embodiment, and FIGS. 2-6 depict various views of the retention clip 100 according to another example embodiment. Referring now to FIGS. 1-6, the retention clip 100 may operably couple the wheel cover 120 to the wheel 130. In this regard, the retention clip 100 of some cases may include a first leg 140, a second leg 150, an engagement portion 160, and a base portion 170. The first leg 140 and the second leg 150 may be operably coupled to the interior surface 124 of the cover portion 122 and may extend perpendicularly away from the interior surface 124 of the wheel cover 120. In this regard, the first and second legs (140, 150) may be formed from a same material as the wheel cover 120 itself, perhaps via an injection molding process. Thus, the first and second legs (140, 150) may extend directly out of the interior surface 124. The base portion 170 may operably couple to the first and second legs (140, 150) and to the interior surface 124 to provide additional support for the first and second legs (140, 150). As such, the base portion 170 may be operably coupled to each of the interior surface 124, the first leg 140, and the second leg 150 to support the retention clip 100. During installation of the wheel cover 120, and while the wheel cover 120 is installed on a vehicle in use, the first and second legs (140, 150) may be subject to stress forces within the material of the first and second legs (140, 150) as the retention clip 100 may be in use operably coupling the wheel cover 120 to the wheel 130. The base portion 170 may therefore operably couple to the first and second legs (140, 150) to provide additional support against the stress forces experienced by the first leg 140 and the second leg 150.

In some cases, the base portion 170 may include a first flange 172 and a second flange 174. The first and second flanges (172, 174) may extend perpendicularly up away from the interior surface 124 along the first and second legs (140, 150), respectively. The first and second flanges (172, 174) may be operably coupled to the first and second legs (140, 150), respectively, and may help distribute some of the stress forces that may build up in the first and second legs (140, 150). As seen in FIGS. 2-6, the first and second flanges (172, 174) may be substantially planar. In this regard, the first and second flanges (172, 174) may lie in respective first and second planes (200, 202). The first and second planes (200, 202) may be substantially parallel to each other, and spaced apart from each other by a distance approximately equal to a width of the base portion 170. In an example embodiment, the first and second planes (200, 202) may be within a range of about 0° to about 5° of being parallel to one another to be considered “substantially” parallel. As also seen in FIGS. 2-6, the first and second legs (140, 150) may be substantially planar as well. In this regard, the first and second legs (140, 150) may be substantially coplanar, and they may both lie in a third plane 204. In some cases, the third plane 204 may be substantially perpendicular to both the first and second planes (200, 202). In an example embodiment, the first and second planes (200, 202) may be within a range of about 0° to about 5° of being perpendicular to the third plane 204 to be considered “substantially” perpendicular. The first and second flanges (172, 174) may extend through the first and second legs (140, 150), and as such, the first and second planes (200, 202) may extend through the third plane 204 as well. Accordingly, the respective intersections of the first and second flanges (172, 174) with the first and second legs (140, 150) may substantially resemble a “plus” shape (+). The reason for this may be so that the first and second flanges (172, 174) may be able to provide stronger support for the first and second legs (140, 150), respectively, so that the first and second legs (140, 150) may be less likely to move or bend in the direction substantially parallel to the direction of extension of the first and second planes (200, 202).

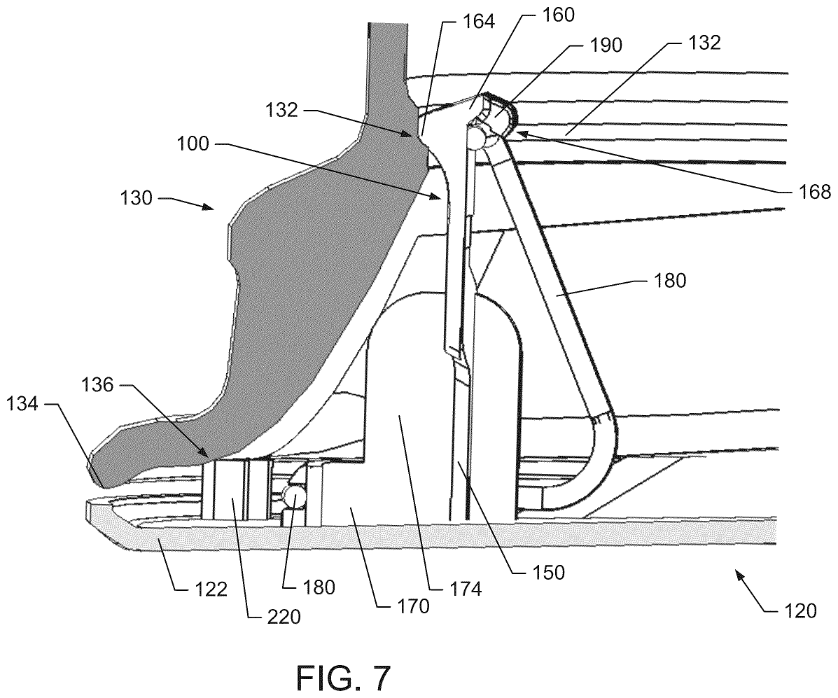

At a distal end of the first and second legs (140, 150) from the base portion 170, the retention clip 100 may include the engagement portion 160. The engagement portion 160 of the retention clip 100 may be the portion of the clip 100 that physically engages with a retention notch 132 of the wheel 130 to operably couple the wheel cover 120 to the wheel 130. The operable coupling of the engagement portion 160 to the wheel 130 will be discussed in more detail below in reference to FIG. 7. In FIG. 1, the engagement portion 160 is depicted as the region above the broken lines 161 and 162. The broken lines 161 and 162 merely depict where the engagement portion 160 begins, and the first and second legs (140, 150) end, since the engagement portion 160 may be integrally formed with the first and second legs (140, 150). The engagement portion 160 of the clip 100 may include an engagement projection 164, which may be defined by an area of increased thickness of the engagement portion 160 at the distal end of the first and second legs (140, 150). The engagement projection 164 may be shaped and sized to operably couple with the retention notch 132 of the wheel 130, which again will be discussed in greater detail below in reference to FIG. 7. At a distal most edge of the retention clip 100 in the engagement portion 160, the first leg 140 and the second leg 150 may be operably coupled to each other such that the engagement portion 160 may be one continuous surface disposed at the top of the clip 100 that may split into the first and second legs (140, 150) moving towards the base portion 170.

In some cases, the retention assembly 110 may further include a biasing member 180 operably coupled to the retention clip 100. In an example embodiment, the retention assembly 110 may include a plurality of retention clips 100 and a plurality of biasing members 180, where each individual instance of the retention clip 100 may include a respective biasing member 180 operably coupled thereto. In some cases, the biasing member 180 may bias the engagement portion 160, and more specifically the engagement projection 164, into engagement with the retention notch 132 of the wheel 130. To do so, the biasing member 180 may be operably coupled to the base portion 170 and the engagement portion 160 to provide a biasing force onto the engagement portion 160 in a direction perpendicular to the direction of extension of the first and second legs (140, 150) and into the retention notch 132. In some cases, the biasing member 180 may be a structural wire disposed around an exterior of the retention clip 100 and may apply a spring force onto the engagement portion 160. In such cases, the base portion 170, the first leg 140, the second leg 150 and the engagement portion 160 may each include locking members 190 that may receive the biasing member 180 therein. The locking members 190 may define a gap within the locking members 190 that may extend around the clip 100 and may receive the biasing member 180 therein. In other words, the locking members 190 may include tabs, as can be seen at the base portion 170 and the engagement portion 160 shown in FIGS. 2-6, that may define the gap between the tabs. At the first and second legs (140, 150), the gap may simply be formed into an exterior edge of the first and second legs (140, 150). In any case, the biasing member 180 may operably couple to the clip 100 by fitting into the gap via a snap fit and being held in place by the locking members 190 accordingly.

The biasing member 180 of some embodiments may be a continuous wire that may extend around the clip 100. In this regard, the biasing member 180 may extend along a front side 176 of the base portion 170 and be operably coupled thereto by the locking members 190. The biasing member 180 may then wrap around the corners of the base portion 170 at approximately 90° and extend parallel to the first and second planes (200, 202) towards, and beyond, the first and second legs (140, 150). At an opposite side of the first and second legs (140, 150) from the front side 176, the biasing member 180 may bend upwards towards the engagement portion 160 to operably couple with the engagement portion 160 at a back side 168 of the retention clip 100. In this regard, the biasing member 180 may leverage its operable coupling to the front side 176 to create the biasing force that may be applied in a radially outward direction at the back side 168 of the engagement portion 160. In other words, the biasing member 180 may use the front side 176 as an anchor to apply the biasing force to the back side 168 of the engagement portion 160.

The biasing member 180 may extend upward towards the back side 168 at an angle a measured from the portion of the biasing member 180 that extends through the first and second legs (140, 150) to the bent portion of the biasing member 180 extending upward towards the engagement portion 160. In some cases, the angle a may be within the range of about 50° to about 80°. In some cases, the angle a may be approximately 65°. The value of the angle a may define the magnitude of the biasing force that the biasing member 180 may exert on the engagement portion 160. For example, on one hand, if the angle a were to be too large, then the magnitude of the biasing force may be too low and the retention clip 100 may not apply enough force to the retention notch 132 to properly operably couple the wheel cover 120 to the wheel 130. On the other hand, if the angle a were to be too small, then the magnitude of the biasing force may be too high and the retention clip 100 may make the wheel cover 120 difficult to install on the wheel 130 or may reduce the longevity of the retention clip 100 by being too rigid.

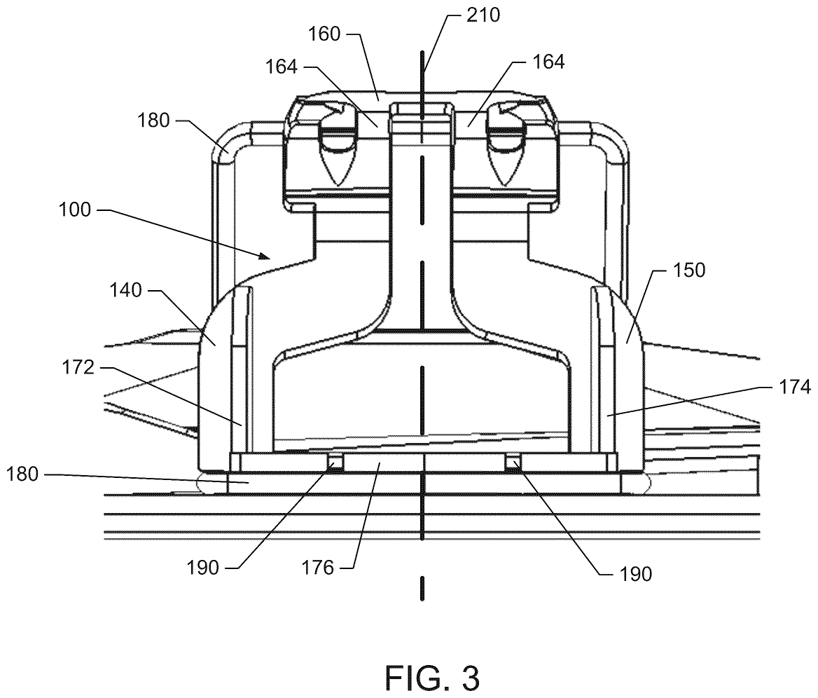

As shown best in FIGS. 1 and 3, the first and second legs (140, 150) of some embodiments of the clip 100 may be symmetrical to each other about a longitudinal axis 210. The symmetry of the first and second legs (140, 150) may allow the retention clip 100 to more evenly distribute forces throughout the components of the clip 100 so that the clip 100 may provide a more robust operable coupling of the wheel cover 120 to the wheel 130. Additionally, this symmetry may help the first and second legs (140, 150) of the retention clip 100 move and react in unison so that one leg does not deflect more, or deflect due to less force, than the other. In other words, the first and second legs (140, 150) may be more likely to possess the same properties and perform the same way as a result of being symmetrical with one another, which may enhance the performance and durability of the retention clip 100.

The retention assembly 110 may further include a plurality of spacer members 220 disposed at the interior surface 124. The spacer members 220, similar to the retention clip 100, may be formed from a same material as the cover portion 122 perhaps during an injection molding process of the cover portion 122. The spacer members 220 may extend perpendicularly away from the interior surface 124 as well, but may be shorter than the retention clip 100. In this regard, the spacer members 220 may be approximately the same height as the front side 176 of the base portion 170 of the clip 100. The spacer members 220 may contact the wheel 130 when the wheel cover 120 is installed on the wheel 130 in order to define an offset space between the cover portion 122 and an outer lip 134 of the wheel 130 so that the cover portion 122 may not contact the outer lip 134 of the wheel 130 and generate unwanted vibrations and noises while the vehicle is driven. According to an example embodiment, each retention clip 100 may be flanked on either side by a spacer member 220. Thus, in other words, the retention assembly 110 may include two spacer members 220 for each individual retention clip 100.

In some cases, the spacer members 220 may simply be extrusions of the interior surface 124. In an example embodiment, the spacer members 220 may be substantially U shaped. The U shape may make the spacer members 220 less likely to break off of the interior surface 124 due to repeated use over time than planar shaped spacer members 220 would be. In some other cases, the spacer members 220 may include an insulating cover that may interface with the wheel 130 to reduce vibrations and noises even further. In an example embodiment, the offset space between the cover portion 122 and the wheel 130 defined by the spacer members 220 may be within a range of about 1 mm to about 3 mm. In some cases, the offset space defined by the spacer members 220 may be approximately 2.5 mm. The offset space should not be too large because then the aerodynamic performance of the wheel cover 120 may be reduced if the wheel cover 120 were to stick out too far from the wheel 130. The offset space should also not be too small because then the cover portion 122 may be more likely to rattle against the outer lip 134 of the wheel 130 while the vehicle may be driven.

FIG. 7 depicts a cross section view of the operable coupling between the wheel cover 120 and the wheel 130. As mentioned above, the retention clip 100 may include an engagement portion 160 that may be disposed at the distal end of the first and second legs (140, 150). The engagement portion 160 may include the engagement projection 164 which may be biased into the retention notch 132 of the wheel 130 by the biasing member 180 to operably couple the wheel cover 120 to the wheel 130. In FIG. 7, the lighter gray shaded region represents the section view through the cover portion 122 and the darker gray shaded region represents the section view through the wheel 130. As seen in FIG. 7, the outer lip 134 of the wheel 130 and the edge of the cover portion 122 may be the portions of the wheel 130 and the wheel cover 120 that may be disposed closest together when the wheel cover 120 may be operably coupled to the wheel 130.

FIG. 7 also depicts the spacer member 220 contacting the wheel 130 at an arcuate portion 136 of the wheel 130 disposed radially inward from the outer lip 134. Thus, the spacer member 220 may be sized such that, due to its contact with the wheel 130 at the arcuate portion 136, the offset space between the outer lip 134 and the edge of the cover portion 122 may be within a range of about 1 mm to about 3 mm. The engagement projection 164 may include a convex rounded profile, which may more easily operable couple the engagement portion 160 to the retention notch 132. In this regard, the retention notch 132 may include a complementarily shaped concave rounded profile such that the engagement projection 164 may be easily, yet reliably, operably coupled to the retention notch 132. The rounded profiles of both the retention notch 132 and the engagement projection 164 may not only enhance the installation of the wheel cover 120, but also its removal. In this regard, the wheel cover 120 may be removed by simply applying a force on the cover portion 122 in a direction parallel to an axis of rotation of the wheel 130. The complementary rounded profiles of the retention notch 132 and the engagement projection 164 may ensure that the retention clip 100 can slide out of its operable coupling with the wheel 130 without applying enough force to the cover portion 122 to break any components of the retention assembly 110.

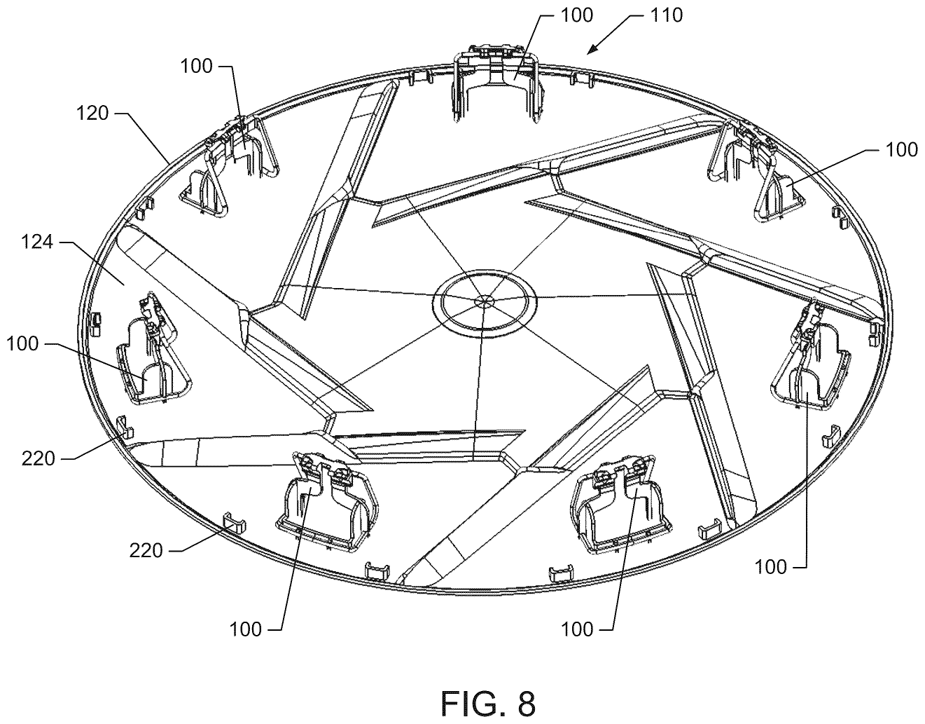

FIG. 8 depicts a perspective view of the wheel cover 120 and the retention assembly 110. As mentioned above, the retention assembly 110 may include a plurality of retention clips 100, a plurality of biasing members 180, and a plurality of spacer members 220. According to an example embodiment, the components of the retention assembly 110 may be radially distributed, and spaced equidistantly apart from each other, along the interior surface 124 of the cover portion 122. In this regard, the retention assembly 110 may therefore evenly distribute stress forces from each retention clip 100 across the entire retention assembly 110 symmetrically, and all of the retention clips 100 may accordingly act as a single spring. The number of respective retention clips 100, biasing members 180 and spacer members 220 may depend on many factors which may include, but not be limited to, the size of the wheel 130 and the spoke 230 design of the wheel 130. In some cases, the retention assembly 110 may include anywhere between eight and sixteen individual retention clips 100 and biasing members 180. The retention assembly 110 may allow for tool free installation and removal of the wheel cover 120 in some example embodiments.

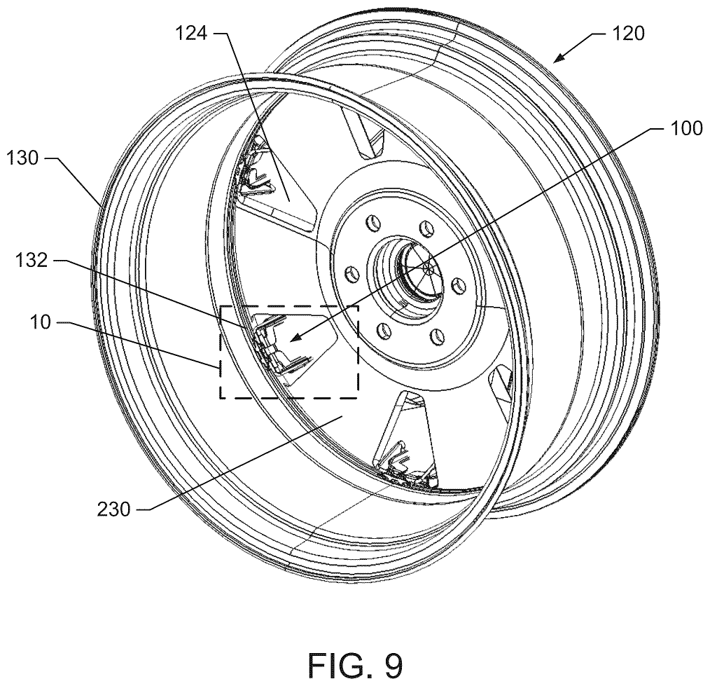

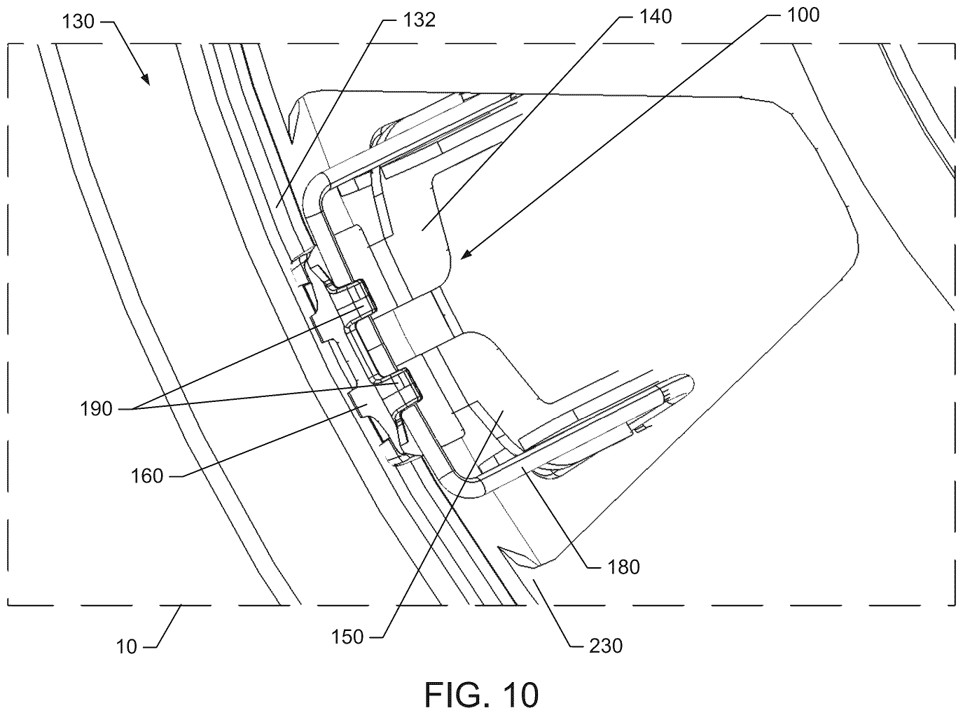

FIGS. 9 and 10 each depict rear perspective views of the wheel 130 having the wheel cover 120 operably coupled to a front of the wheel 130. FIG. 10 depicts a close up view of a retention clip taken from box 10 in FIG. 9. FIGS. 9 and 10 both show how the retention clips 100 of the wheel cover 120 extend through a gap in between consecutive spokes 230 of the wheel 130 to reach the retention notch 132 and operably couple the wheel cover 120 to the wheel 130. As mentioned above, the total number of retention clips 100 of the retention assembly 110 may vary depending on the particular wheel 130 and how the spokes 230 of the wheel 130 are designed (i.e. how many spokes 230 there are, how the spokes 230 are spaced out, etc.). This may be because the retention clips 100 may need to extend past the spokes 230 to reach the retention notch 132 of the wheel 130 in some cases.

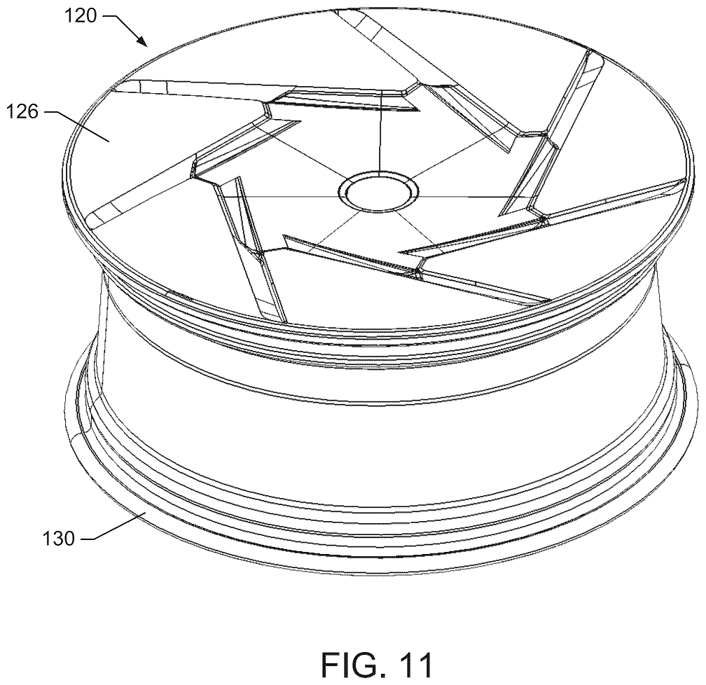

FIG. 11 depicts the wheel cover 120 operably coupled to the wheel 130 from a front perspective view. In this view, the retention assembly 110 may not be visible, which may be by design. The retention assembly 110 may be hidden between the cover portion 122 and the wheel 130 such that the exterior surface 126 of the wheel cover 120 may be optimized for aerodynamic performance and visual appeal.

A wheel cover for a wheel of a vehicle of an example embodiment may therefore be provided. The wheel cover may include a cover portion that may include an interior surface that may face inwardly towards the wheel and an exterior surface that may face outwardly away from the wheel, and a retention assembly which may be disposed at the interior surface, the retention assembly may operably couple the wheel cover to the wheel. The retention assembly may include a first retention clip that may extend perpendicularly away from the interior surface and may interface with a retention notch of the wheel, and a first biasing member which may operably couple to a front side and a back side of the first retention clip. The first biasing member may bias the first retention clip to operably couple with the retention notch by engaging the front side to urge the back side in a radially outward direction with respect to the cover portion.

The wheel cover of some embodiments may include additional features, modifications, augmentations and/or the like to achieve further objectives or enhance performance of the wheel cover. The additional features, modifications, augmentations and/or the like may be added in any combination with each other. Below is a list of various additional features, modifications, and augmentations that can each be added individually or in any combination with each other. For example, the engagement portion may include an engagement projection that may engage the retention notch of the wheel to retain the wheel cover on the wheel. In an example embodiment, the base portion, the first leg, the second leg, and the engagement portion may each include locking members to operably couple to the first biasing member. In some cases, the first biasing member may operably couple to the locking members via a snap fit. In an example embodiment, the retention assembly may include a plurality of retention clips and biasing members disposed at the interior surface. In some cases, each retention clip of the plurality of retention clips may be operably coupled to a respective biasing member. In an example embodiment, the plurality of retention clips may be disposed radially around the interior surface and spaced apart equidistantly from each other. In some cases, the retention assembly may further include a plurality of spacer members disposed radially around the interior surface. In an example embodiment, the spacer members may contact the wheel to space apart the interior surface from the wheel. In some cases, the base portion may include a first flange operably coupled to the first leg and a second flange operably coupled to the second leg. In an example embodiment, the first flange and the second flange may distribute stress forces from the first and second legs. In some cases, the first flange and the second flange may lie in first and second planes, respectively, and the first leg and the second leg may lie in a third plane. In an example embodiment, the first and second planes may be parallel to each other and may be disposed perpendicularly to the third plane. In some cases, the first leg and the second leg may be operably coupled to each other at the engagement portion. In an example embodiment, the first and second legs may be symmetrical about a longitudinal axis of the first retention clip. In some cases, the first retention clip may include a first leg that may extend perpendicularly away from the interior surface, a second leg that may extend perpendicularly away from the interior surface, an engagement portion that may be disposed at a distal end of the first and second legs, the engagement portion may operably couple with the retention notch, and a base portion that may be operably coupled to the first leg, the second leg, and the interior surface to support the first retention clip. In an example embodiment, the first biasing member may be operably coupled to each of the base portion and the engagement portion of the first retention clip to bias the engagement portion into the retention notch.

A retention assembly for operably coupling a wheel cover to a wheel of a vehicle may therefore be provided. The retention assembly may include a first retention clip that may extend perpendicularly away from an interior surface of the wheel cover and may interface with a retention notch of the wheel, and a first biasing member which may operably couple to a front side and a back side of the first retention clip. The first biasing member may bias the first retention clip to operably couple with the retention notch by engaging the front side to urge the back side in a radially outward direction with respect to the cover portion.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A wheel cover for a wheel of a vehicle, the wheel cover comprising:
a cover portion comprising an interior surface that faces inwardly towards the wheel and an exterior surface that faces outwardly away from the wheel; and
a retention assembly disposed at the interior surface, the retention assembly being configured to operably couple the wheel cover to the wheel, the retention assembly comprising:
a first retention clip that extends perpendicularly away from the interior surface and interfaces with a retention notch of the wheel; and
a first biasing member operably coupled to a front side and a back side of the first retention clip,
wherein the first biasing member biases the first retention clip to operably couple with the retention notch by engaging the front side to urge the back side in a radially outward direction with respect to the cover portion.

2. The wheel cover of claim 1, wherein the first retention clip comprises:
a first leg extending perpendicularly away from the interior surface;
a second leg extending perpendicularly away from the interior surface;
an engagement portion disposed at a distal end of the first and second legs, the engagement portion being configured to operably couple with the retention notch; and
a base portion operably coupled to the first leg, the second leg, and the interior surface to support the first retention clip,
wherein the first biasing member is operably coupled to each of the base portion and the engagement portion of the first retention clip to bias the engagement portion into the retention notch.

3. The wheel cover of claim 2, wherein the engagement portion comprises an engagement projection that engages the retention notch of the wheel to retain the wheel cover on the wheel.

4. The wheel cover of claim 2, wherein the base portion, the first leg, the second leg, and the engagement portion each comprise locking members to operably couple to the first biasing member.

5. The wheel cover of claim 4, wherein the first biasing member operably couples to the locking members via a snap fit.

6. The wheel cover of claim 2, wherein the base portion comprises a first flange operably coupled to the first leg and a second flange operably coupled to the second leg,
wherein the first flange and the second flange distribute stress forces from the first and second legs.

7. The wheel cover of claim 2, wherein the first leg and the second leg are operably coupled to each other at the engagement portion.

8. The wheel cover of claim 2, wherein the first and second legs are symmetrical about a longitudinal axis of the first retention clip.

9. The wheel cover of claim 1, wherein the retention assembly comprises a plurality of retention clips and biasing members disposed at the interior surface, and
wherein each retention clip of the plurality of retention clips is operably coupled to a respective biasing member.

10. The wheel cover of claim 9, wherein the plurality of retention clips are disposed radially around the interior surface and spaced apart equidistantly from each other.

11. The wheel cover of claim 1, wherein the retention assembly further comprises a plurality of spacer members disposed radially around the interior surface, and
wherein the spacer members contact the wheel to space apart the cover portion from the wheel.

12. A retention assembly for operably coupling a wheel cover to a wheel of a vehicle, the retention assembly comprising:
a first retention clip that extends perpendicularly away from an interior surface of the wheel cover and interfaces with a retention notch of the wheel; and
a first biasing member operably coupled to a front side and a back side of the first retention clip,
wherein the first biasing member biases the first retention clip to operably couple with the retention notch by engaging the front side to urge the back side in a radially outward direction with respect to the cover portion.

13. The retention assembly of claim 12, wherein the first retention clip comprises:
a first leg extending perpendicularly away from the interior surface;
a second leg extending perpendicularly away from the interior surface;
an engagement portion disposed at a distal end of the first and second legs, the engagement portion being configured to operably couple with the retention notch; and
a base portion operably coupled to the first leg, the second leg, and the interior surface to support the first retention clip,
wherein the first biasing member is operably coupled to each of the base portion and the engagement portion of the first retention clip to bias the engagement portion into the retention notch.

14. The retention assembly of claim 13, wherein the engagement portion comprises an engagement projection that engages the retention notch of the wheel to retain the wheel cover on the wheel.

15. The retention assembly of claim 13, wherein the base portion, the first leg, the second leg, and the engagement portion each comprise locking members to operably couple to the first biasing member.

16. The retention assembly of claim 13, wherein the base portion comprises a first flange operably coupled to the first leg and a second flange operably coupled to the second leg,
wherein the first flange and the second flange distribute stress forces from the first and second legs.

17. The retention assembly of claim 13, wherein the first leg and the second leg are operably coupled to each other at the engagement portion, and
wherein the first and second legs are symmetrical about a longitudinal axis of the first retention clip.

18. The retention assembly of claim 12, wherein the retention assembly comprises a plurality of retention clips and biasing members disposed at the interior surface, and
wherein each retention clip of the plurality of retention clips is operably coupled to a respective biasing member.

19. The retention assembly of claim 18, wherein the plurality of retention clips are disposed radially around the interior surface and spaced apart equidistantly from each other.

20. The retention assembly of claim 12, wherein the retention assembly further comprises a plurality of spacer members disposed radially around the interior surface, and
wherein the spacer members contact the wheel to space apart the wheel cover from the wheel.
